(19) United States
(12) Patent Application Publication
(10) Pub. No.: US 2012/0242072 A1
(43) Pub. Date: Sep. 27, 2012

(54) METHOD FOR PRODUCING A SUPPORT COMPRISING AN ELECTRONIC DEVICE

(75) Inventors: Thibaut LeLoarer, Pommier De Beaurepaire (FR); Pascal Marlin, Coulommiers (FR)

(73) Assignee: Arjowiggins Security, Boulogne Billancourt (FR)

(21) Appl. No.: 13/504,621

(22) PCT Filed: Oct. 26, 2010
(86) PCT No.: PCT/IB10/54838

§ 371 Date: Jun. 6, 2012

(30) Foreign Application Priority Data
Oct. 27, 2009 (FR) 09 05177

(51) Int. Cl. B32B 37/14; B32B 38/14; B42D 15/00; B32B 38/10

(52) U.S. Cl. 283/67; 156/60; 156/264; 156/277; 283/72

(57) ABSTRACT

The invention relates to a method for producing a support comprising at least one electronic device (6), according to which the electronic device (6) is introduced, by means of a grip-release tool, into a first layer (2) of the support, made from at least one polymer material.

The subject of the present invention is a method for producing a support that can be cut into a plurality of support units each incorporating at least one electronic device, and such a support itself.

The invention applies to any support made of polymer material comprising at least one integrated electronic device and, more particularly, although not exclusively, to the production of security documents, the latter for example being identity documents or payment means, booking receipts (vouchers), gift certificates, events tickets, transport tickets but also labels or other documents, notably interactive ones, for example maps, notably road maps.

The support can, for example, be cut into a plurality of support units intended to be inserted into a fibrous mixture of a papermaking machine for example, the fibrous mixture notably being used to produce items such as security documents or banknotes. Such support units are commonly known as “flakes”.

To make a document secure it is known practice to use security elements known as “level-one security” elements which comprise security elements that can be detected by the naked eye under visible light and without the use of special equipment and/or security elements known as “level-two security” elements which are detectable only using relatively simple equipment such as a light bulb that emits in the ultraviolet or the infrared. It may prove desirable to use security elements known as “level-three security” elements which also comprise electronic devices capable of generating a specific signal when subjected to optoelectronic, electrical, magnetic or even electromagnetic excitation.

The presence of such security elements within a support may require compensation for the additional thickness generated within the support by the presence of the electronic device in order to protect the latter and/or make it less detectable and/or make it easier to print on the surface of the support.

Application WO 03/015016 teaches the integration of an electronic device in a fibrous layer without generating any additional thickness therein thanks to the use of a strip bearing the electronic device, which strip is incorporated into the fibrous layer at the time that the latter is formed.

Application WO 2008/060708 teaches how to position an electronic device within a support, this device being inserted into a cavity created in the support beforehand or inserted while locally compressing the support.

The step that involves creating a cavity in the support beforehand into which to insert the electronic device may prove relatively complicated to implement and costly in terms of time.

Application WO 2009/043690 teaches how to insert into a support made of polymer material an electronic device which is incorporated into the support before the latter is extruded.

Application US 2008/0291020 teaches how to insert a plurality of paper wafers into a mixture of papermaking fibers during the production of an item such as a collectable trading card.

There is a need for at least one electronic device to be inserted simply and quickly into a support comprising at least one layer made of at least one polymer material, notably in order to achieve satisfactory production rates for such supports.

Application US 2007/0141760 describes a “reel-to-reel application of chips which are stored on a roll and then compressed to insert them into the material.

Application FR 2 701 139 describes a thermoplastic material which creeps under the effect of pressure and temperature.

It is an object of the invention to meet this requirement and the invention achieves this, according to one of its aspects, using a method of producing a support comprising at least one electronic device, in which method a pick and place tool is used to insert the electronic device into a first layer of the support produced from at least one polymer material. The use of a pick and place tool (also known as a pick and place device) in the electronics industry allows the electronic device to be inserted simply and quickly into the support. Such a tool also makes it possible to work directly with the desired format and to achieve high manufacturing rates.

The electronic device can be housed without generating any appreciable additional thickness in the first layer. What is meant by “without generating any appreciable additional thickness” is that the thickness of the entity formed by the first layer and the electronic device inserted therein, at the location of the electronic device, is between 95 and 105% of that of the first layer elsewhere.

A support comprising such an electronic device may have a high level of security and meet traceability and/or authentication requirements. The method may include the step whereby the first layer is assembled under mechanical stress with at least one second layer of the support, so that the electronic device is situated between the external faces of the two layers thus assembled.

The electronic device may be chosen from contactless communication integrated microcircuits, chip-based integrated-antenna microcircuits, resonant microcircuits, microcircuits that communicate electromagnetically, microtransponders, microtransponders which are photoactivatable, notably using a laser beam, and microtrans-ponders that react to a beam of light, for example of diffuse light.

The electronic device may or may not be programmable. The electronic device may be a read-only or a read/write device.

Each layer may comprise at least one core sublayer comprising voids and/or at least one skin sublayer that is free of voids. What is meant by a “core sublayer” is that this sublayer is further away from the surface of the layer than a skin sublayer.

The presence of voids in the core sublayer gives it a density lower than 1 and increases its compressibility, making it easier for the electronic device to be inserted into the layer using the pick and place tool, and may also make printing on the support ultimately obtained easier, for example using copperplate printing. The copperplate printing is performed using a fatty ink that does not dry fully. It is in relief and in itself constitutes a security element. Within the meaning of the invention, the compressibility of a layer or sublayer is defined by the ZWICK standard and corresponds to the difference in thickness between an unstressed configuration and a stressed configuration.

A support produced using layers comprising such core sublayers is notably suited to copperplate printing methods and to any other treatment that generates a tactile effect. The support obtained may have raised print equivalent to that obtained with a paper support and with very sharp detail.

The skin sublayer may be an adhesive sublayer or a print sublayer.

Each layer of the substrate may comprise a core sublayer and two skin sublayers, the core sublayer being sandwiched between these two skin sublayers.

One of the two skin sublayers is, for example, an adhesive sublayer and the other of the two skin sublayers is a print sublayer.

As an alternative, the two skin sublayers are of the same type, for example adhesive or print sublayers.

A support according to the invention may have print durability and mechanical properties which are an improvement over a paper support. A support according to the invention has, for example, very good print rendering and good contrast, which means that fine structures that counterfeiters find difficult to reproduce can be printed sharply thereon.

The electronic device may contain an RFID microcircuit. This may be a contactless communication integrated microcircuit, an on-chip integrated-antenna microcircuit or a resonant microcircuit. A support with an integrated-antenna microcircuit on a chip may have a small thickness, making it easier to compensate for the additional thickness generated by the microcircuit in the support.

When the electronic device comprises an on-chip integrated-antenna microcircuit, this integrated antenna may be the only antenna of the support or may be coupled to an amplifying antenna, also known as a booster antenna, integrated into the support. The presence of such a booster antenna may make it possible to increase the detection range of the chip, for example by a factor of 100. Further, such a booster antenna may provide a means of personalizing the support.

As an alternative, the electronic device may have no antenna and be configured to be connected to an antenna belonging to the support, for example by soldering or bonding using a conducting glue. The antenna may be a wire antenna or some other form of antenna, for example a screen-printed or engraved antenna.

The electronic device can be inserted into the first layer through a void-free skin sublayer of said first layer and into the thickness of a core sublayer of said layer that does include voids. The skin sublayer through which the electronic device is inserted is, for example, an adhesive sublayer.

The second layer or layers may be made of the same polymer material as the first layer. As an alternative, they may have a different composition.

According to a first embodiment of the invention, the electronic device is inserted into the first layer using the pick and place tool by compressing this layer at a location that has no cavity, notably thanks to the compressibility of the core sublayer of the first layer.

Following this insertion step, the electronic device is, for example, partially housed in at least 20%, better 40%, better 60%, better 80%, better 100%, of the thickness of the core sublayer of the first layer.

The adhesive layer may be a hot melt layer or may comprise a pressure-sensitive adhesive.

The pick and place tool can be configured to heat the support and/or the electronic device, particularly where there is a hot melt adhesive layer that is to be crossed when inserting the electronic device using the pick and place tool. Heating may be to a temperature of 80° C. or higher.

Prior to assembling the first and second layers, that face of the first layer via which the electronic device has been inserted can be positioned facing the other layer.

The first and second layers assembled may be two separate layers or, as an alternative, may correspond to the same layer which has previously been folded over onto itself.

When each layer comprises at least one adhesive sublayer, the adhesive skin sublayers of the first and second layer may, during the assembly step, come into contact with one another.

When each layer comprises an adhesive skin sublayer and a print sublayer, the print sublayer of each layer may, after assembly, define the exterior faces of the support obtained.

As an alternative, during the assembly step, the adhesive sublayer of one layer comes into contact with the print sublayer of the other layer. The exterior faces of the support obtained can then be defined by one print sublayer and one adhesive sublayer.

According to a second embodiment of the invention, the electronic device is inserted using the pick and place tool into a cavity of the first layer. This cavity may extend over the entire thickness of the first layer or, as an alternative, be formed solely in all or part of the thickness of the core sublayer and/or in one of the skin sublayers. At the time of assembly, the first layer may be positioned between two other layers, also known as second layers, said first layer comprising a core sublayer that has voids and two adhesive skin sublayers, the core sublayer being sandwiched between these two adhesive skin sublayers.

The other two layers that are assembled with the first layer may each have an adhesive skin sublayer and a print skin sublayer.

The two other layers may be identical or of different composition.

The first layer may comprise a core sublayer bordered by two adhesive skin sublayers.

During the assembly step, the two adhesive sublayers of the first layer may respectively come into contact with the adhesive sublayer of each other layer so that on completion of this assembly step, the exterior faces of the support are each defined by a print sublayer. The method may comprise the step whereby at least one printing operation is performed on at least one print sublayer of the support. This for example is the printing of a security pattern, notably using a fluorescent ink.

The polymer material from which the first layer of the support is made is, for example, based on polyolefin or polyethylene.

More specifically, the material used may be porous and may become more dense upon insertion of the electronic device. Such a material does not creep under the effect of pressure and temperature.

The method may include the step whereby at least one security element is placed on an external face of the support. Such a security element may be a level-1 security element, a level-2 security element, or a level-3 security element. It is, for example, an identification pattern printed using a fluorescent ink, an impressed watermark, a holographic foil, or even a tracker capable of generating a specific signal when subjected to external excitation or a suitable chemical marker or “tagger”. Such a support which comprises several security elements may have a relatively high level of security.

The support obtained may have no fibrous layer.

The support may comprise just one electronic device or, as an alternative, comprise several, for example between 2 and 8, thereof.

The support may have a total thickness of between 70 μm and 350 μm.

The first layer and/or the second layer or layers may each comprise a single core sublayer that has voids. As an alternative, said layer or layers comprise several core sublayers that have voids.

The support may have no second layer(s) and the method may include the step whereby at least one face of the first layer is coated off-line or in-line with a heat-sealable lacquer on at least one face out of the face of the adhesive sublayer opposite to the core sublayer and the face of the print sublayer opposite to the core sublayer.

A first coat of lacquer is for example coated onto the adhesive sublayer in such a way that the adhesive sublayer is sandwiched between the first coat of lacquer on the one hand and the core sublayer on the other, this first coat of lacquer then defining the recto face of the support. Such a coat of lacquer may improve the protection of the electronic device inserted into the support, for example with respect to corrosion.

A second coat of lacquer is, for example, coated onto the print sublayer so that the latter is sandwiched between the core sublayer and the second coat of lacquer, this second coat of lacquer defining the verso face of the support.

The lacquer can be applied in such a way as to define the verso face and the recto face of the support. When the support units cut from the support are intended to be incorporated into a fibrous article, for example a papermaking item, use of such a lacquer may encourage the binding of support units in the finished item.

As an alternative, only the first coat of lacquer is coated onto the adhesive sublayer through which the electronic device or devices are inserted and printing is applied to the print sublayer. This printing for example corresponds to a solid expanse of ink that is invisible to the naked eye but visible under UV or IR light. This printing may be done in line with the electronic device and constitute a reference mark for a subsequent step of cutting the support.

The lacquer for example contains a fluorescent ink and may have adhesive properties. This step of coating with lacquer is notably encouraged by the introduction of electronic device(s) into the first layer without the generation of additional thickness.

During a later step, the support, with or without layer(s) of lacquer and with or without second layer(s), can be cut, for example using a laser, to create a plurality of support units. Each support unit may contain one or more electronic devices. Alternatively, the support may be cut by two successive coaxial rolls, each of the rolls bearing a complementary cutting pattern which interpenetrates with the other pattern to form a resultant pattern that will form the support unit as described in patent EP1718441.

The surface area of a support unit is advantageously greater than that of the electronic device, the latter for example being fully located inside the surface area of the support unit. Advantageously, the support units are cut with respect to the reference mark in such a way that the electronic device is located at an identifiable position with respect to the shape of the support unit.

The support units can be cut in such a way as to have a decorative shape, for example a geometric pattern such as an ellipse, a circle, a polygon, a rectangle, a square, a star. As an alternative, the support units may define a written symbol, notably an alphanumeric character, or an image of a recognizable object such as an animal, a plant, a logo or a character.

When the print sublayer has been printed on in line with the electronic device, the support unit may be cut along the exterior contour of the pattern or of the solid expanse of ink applied.

Each support unit has, for example, a longest dimension of between 0.5 and 5 mm, having a relatively small format, also being known as “flakes”.

A further subject of the invention, according to another of its aspects, is a method of producing an item, notably a security document, in which:
at least one support unit as defined hereinabove is introduced into a dispersion of fibrous material intended to form a fibrous substrate of the item in a papermaking machine, for example a cylinder-type or Fourdrinier press paper press.

The quantity of support units inserted into the dispersion of fibrous material is, for example, calculated so that the fibrous mixture will be homogenous in terms of the number of support units, meaning that the probability of having the same number of support units per item obtained by cutting such a support up is great, for example 90% or higher.

At least one electronic device of the substrate may be unserviceable, having for example become damaged during the cutting up of the support units.

The item is, for example, a papermaking item, notably being a document. The invention may allow one or more electronic devices to be inserted into the document without having to align to identifying markers on the document.

Moreover, by comparison with introducing an electronic device into a machine for producing a fibrous layer, according to the invention, the electronic devices inserted have already been incorporated into the support, the latter comprising at least the first layer of polymer material protecting the electronic device.

A further subject of the invention is an item, notably a security document such as a passport, an identiy card, a driver's license, an interactive collectable trading card or playing card, a payment means, notably a payment card, a coupon or a voucher, a transport card, a loyalty card, a service entitlement card, a subscription card, produced using the above method.

A further subject of the invention, independently of or in combination with the foregoing, is an item, notably a document, comprising a support comprising:
at least one layer made of at least one polymer material comprising at least one sublayer that has voids, and
an electronic device comprising an on-chip integrated-antenna microcircuit of which at least one part is housed in at least one part of the thickness of said sublayer.

The item is for example a document as defined above, for example a booking receipt, a gift certificate, an event ticket, a label, a map or more generally any article manufactured using a support comprising a layer of polymer material comprising a sublayer that has voids.

The item may have at least one of the features mentioned hereinabove, notably in conjunction with the support layers.

Another subject of the invention, according to another of its aspects, is a fibrous substrate for producing an item, notably a document such as a security document, said substrate comprising a plurality of support units each one comprising at least one electronic device housed within a non-fibrous layer of said support unit.

At least one of the electronic devices of the substrate may be unserviceable.

The support units may have the same features as those obtained on completion of the method of manufacturing the support described above, notably being produced from a support comprising at least one first layer produced from at least one polymer material.

In one particular embodiment of the invention, the support units each comprise a through-hole or an internal perforation and an electronic device inserted in the manner described hereinabove and placed on the support unit but away from the perforation. Such a through-hole or such a perforation may improve the anchorage of the support units in the fibrous substrate.

In another particular embodiment of the invention, the support, incorporating at least one electronic device and obtained using the method defined hereinabove, is in the form of a strip or web and is introduced into a papermaking machine in a dispersion of fibrous material which is intended to form the fibrous substrate of the security document. For preference, the support incorporates several electronic devices which, because they are inserted in strip form, are positioned in a localized region of the security document, this notably making it easier to read the electronic devices. For example, the security strip thus formed has a width of between 2 and 60 mm, preferably of between 4 and 30 mm, and more preferably of between 10 and 20 mm.

The fibrous substrate may further comprise at least one security element known as a “level-one” security element that is detectable to the naked eye in visible light and without the use of special equipment and/or at least one security element known as a “level-two” security element that is detectable only using equipment such as a light bulb emitting in the ultraviolet or the infrared and/or at least one other security element known as a “level-three” security element comprising a tracker capable of generating a specific signal when subjected to external excitation. This security element for example uses an ink that has optical properties that differ according to the illumination, for example that differ in terms of iridescence or visibility.

A further subject of the invention, according to another of its aspects, is a method of authenticating and/or identifying an item, notably a security document, comprising a fibrous substrate comprising at least one support unit each accommodating within a non-fibrous layer at least one electronic device, each support unit notably being obtained using the above method, a code being assigned to each electric device of each support unit, at least one identifier of the item being associated with the item, for example inscribed on said item,

in which method:
a code resulting from the combination of the codes of the electronic devices of the item is determined, and
the item identifier is read, notably visually or automatically, and
the item identifier and the resultant code are compared with a view to authenticating and/or to identifying the item.

The term “code” is to be understood in the broadest sense, meaning for example both numbers and letters recorded in the memory of a chip and, in the case of a resonant microcircuit, a resonant signal.

The item identifier and the code are, for example, compared by applying a mathematical function, for example an encrypting or decrypting function, to at least one out of the resultant code and the identifier.

The same code, or possibly separate codes, may be assigned to several electronic devices of the item and these codes may be read. The resultant code can be determined, for example by concatenation, from the codes read. The item identifier is, for example, a number equal to the resultant code. As an alternative, this identifier is different than the resultant code, giving the authentication a uniqueness.

An electronic device contains for example information specific to it and information relating to at least one other electronic device of the substrate.

The item is for example made from the above fibrous substrate.

The invention may be better understood from reading the description which will follow of some non-limiting examples of how the latter is embodied, and from examining the attached drawing in which:

FIG. 1 schematically depicts a method according to a first embodiment of the invention,

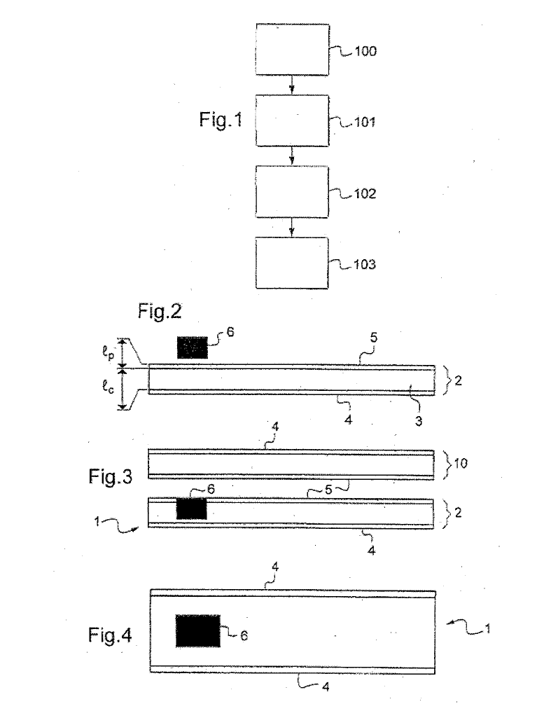

FIGS. 2 to 5 depict steps in the method according to FIG. 1,

FIG. 6 depicts an item obtained on completion of the method according to FIG. 1,

FIGS. 7 to 9 depict steps in the method according to a second embodiment of the invention,

FIG. 10 depicts an item obtained on completion of the method according to FIGS. 7 to 9,

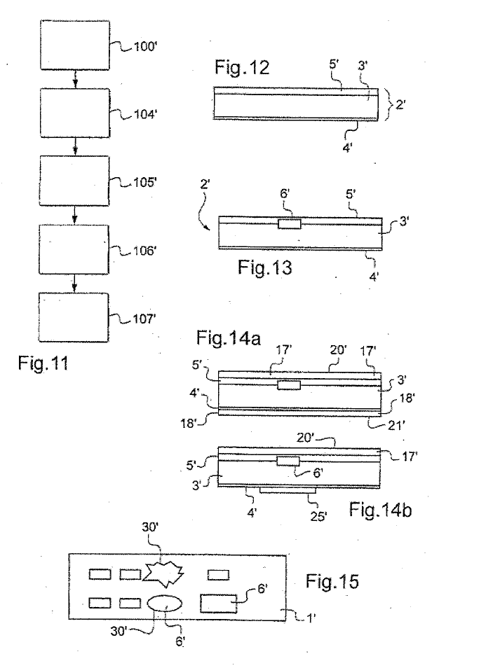

FIG. 11 schematically depicts examples of steps during a method of manufacture according to a third embodiment of the invention, and

FIGS. 12 to 15 depict examples of supports during steps of the method depicted in FIG. 11.

FIG. 1 schematically depicts a method of manufacturing a support 1, which can be cut into support units, according to a first embodiment of the invention.

Prior to a step 100, there is a first layer 2 made of a polymer material, as depicted in FIG. 2. In the example illustrated, the first layer 2 has a core sublayer 3 that has voids. The core sublayer 3 has for example a thickness of between 50 μm and 300 μm.

As depicted in FIG. 2, the first layer 2 may comprise at least one skin sublayer. In the example illustrated, the first layer 2 comprises two skin sublayers, the core sublayer 3 being sandwiched between the two skin sublayers. The layer 2 is, for example, made of Polyart® of the BM1C or BM type, marketed by the company ARJOBEX.

One of the skin sublayers of the first layer 2 is, for example, a print sublayer 4. This print sublayer 4 has for example a thickness of between 5 μm and 40 μm and can be configured to allow copperplate printing.

The second skin sublayer of the first layer 2 is, for example, an adhesive sublayer 5, notably a hot-melt adhesive sublayer, for example polyethylene. This sublayer 5 may have a thickness of between 5 μm and 50 μm.

The sublayers 4 and 5 may have substantially equal thicknesses.

The skin sublayers 4 and 5 preferably have no voids opening onto their surface.

The voids ratio of the first layer 2 may be between 5 and 50%.

The voids ratio of the first layer 2 may notably be determined after this layer 2 has been cut using a beam of ions, for example argon ions, which limits the scratching, filling, tearing or compression of the layer 2, preserves the morphology thereof, and thus makes it easier to determine the porosity.

Having made the cut, observation may be done under an electron microscope, notably using a scanning electron microscope, for instance of the Quanta 200 ESEM type by EFPG. It is then possible to distinguish the various sublayers of the layer 2 and the porosities.

The voids ratio φ can be calculated as the ratio between the total surface area of the voids present in the cross section and the total surface area of the cross section, using the following formula:

$$φ = < \overline{P} s >= \frac{Svoid}{Scross section}$$

As depicted in FIG. 2, at least one electronic device 6 is intended to be inserted into the first layer 2. The electronic device 6 for example comprises a microcircuit of the RFID chip type. This chip may comprise an integrated antenna, being for example a chip of the AOB (antenna on board) or OCA (on chip antenna) type. An example of such an OCA chip is, for example, described on the web site http://www.fecinc.com.my/mmchip/mm on chip antenna.htm. AOB chips that are particularly suitable may have a thickness of between 60 and 80 μm, for example of 70 μm, and a width of between 30 and 50 μm, for example of 40 μm.

As an alternative, the electronic device 6 comprises a resonant microcircuit, a microcircuit that communicates electromagnetically, a microtransponder microcircuit reacting to a beam of diffuse light or a microtransponder that is photoactivatable using a laser beam.

The first layer 2 may have no other antenna than that of the microcircuit 6, notably the one incorporated into the chip of said microcircuit.

As an alternative, the first layer 2 comprises at least one amplifying antenna known as a booster antenna. This booster antenna is for example produced by printing, engraving, screen printing or is a wire antenna. This booster antenna may be coupled electromagnetically to the on-chip antenna of the electronic device and may have a decorative shape, for example form a decorative pattern such as an ellipse, a circle, a polygon, a rectangle, a square, a star. As an alternative, the booster antenna may define a written symbol, notably an alphanumeric character, or an image of a recognizable object such as an animal, a plant, a logo or a character. The booster antenna may or may not form a loop. Insertion of the electronic device 6 into the first layer 2 is performed in the example described using a pick and place tool in step 100, which tool can be configured to heat the electronic device 6 and/or to heat the first layer 2 prior to the insertion of the device 6. The latter is for example inserted by the pick and place tool through the adhesive sublayer 5 and the heating carried out by this pick and place tool softens the adhesive sublayer 5.

On completion of this insertion step, the electronic device 6 may, as depicted in FIG. 3, be housed within the first layer 2, without generating any appreciable additional thickness, which means to say that the thickness of the first layer 2 at the location of the electronic device 6 is between 95% and 105%, notably between 100% and 105%, of that of the first layer 2 elsewhere. The variation in thickness generated by the insertion of the electronic device is compensated by the core sublayer 3 and by the adhesive sublayer 5. The electronic device 6 may, as in the example considered, be of a thickness of between 50% and 90% of the thickness of the core sublayer 3.

FIG. 3 depicts the first layer 2 on completion of the step 100 with an electronic device 6 in the first layer 2 and a second layer 10 prior to assembly of the two layers 2 and 10 during a step 101.

The second layer 10 is for example similar to the first layer 2, comprising a core sublayer 3 and skin sublayers and 5 which are identical to those of the first layer 2. As an alternative, the sublayers of the second layer 10 may have thicknesses and/or be made of materials which differ from those of the first layer 2.

In the example depicted in FIG. 3, the two sublayers 2 and 10 are distinct but, in an alternative form that has not been depicted, the first 2 and second 10 layers correspond to one and the same layer which has been folded over onto itself.

The layers 2 and 10 as depicted in FIG. 3 are than assembled.

This assembly step is performed under mechanical stress, for example using a platen or cylinder press heating the skin sublayers in order to seal the layers 2 and 10 and incorporate the electronic device 6 within the second layer 10. This assembly step corresponds for example to a lamination on a platen press at a temperature of 100° C., at 10 kg/cm2 and for five minutes.

Prior to this step, the first layer 2 and the second layer 10 can be positioned with respect to one another in such a way that, at the time of assembly, the adhesive sublayers 5 belonging to each layer 2 or 10 come into contact with one another, as in the configuration depicted in FIG. 3.

On completion of this step 101, the print sublayer 4 of each layer 2 or 10 therefore defines a recto face and a verso face of the support 1 obtained.

As an alternative, during the assembly step 101, the print sublayer 4 of one of the layers comes into contact with the adhesive sublayer 5 of the other layer, so that on completion of this step, the support 1 comprises a recto or, respectively, a verso face which is defined by a print sublayer and a verso or, respectively, a recto face, that is defined by an adhesive sublayer.

FIG. 4 depicts an example of a support 1 on completion of this step 101. As may be seen, the electronic device 6 is situated between the external faces of the two assembled layers without generating additional thickness in the support 1. Advantageously, the electronic device 6 is thus protected.

The method may further include an optional step 102 during which at least one printing operation is performed on the print sublayer or sublayers 4 defining one or several faces of the support 1, so as to personalize the support. During this step 102 it is possible, also or alternatively, to add one or more security elements to the support 1.

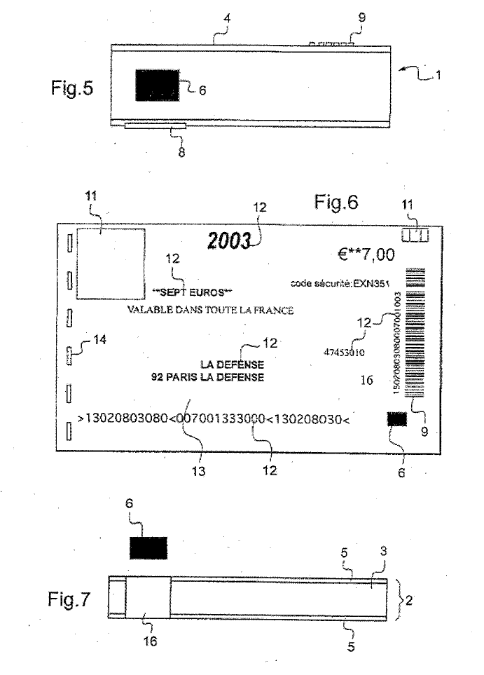

FIG. 5 depicts an example of a support 1 on completion of the step 102. As depicted, a holographic foil 8 is for example carried by the verso face of the support 1 and a barcode 9 is printed on the recto face of the support 1, for example using copperplate printing.

During a later step 103, the support 1 is cut into support units, it being possible for each support unit to be incorporated into an item, it being for example introduced into a machine that produces a fibrous substrate of the item.

FIG. 6 depicts an example of such an item. The item depicted is a document, for example a restaurant ticket, which has a thickness of, for example, between 200 and 300 μm, notably of 220 μm.

The recto face of this document may, in addition to the electronic device 6 as illustrated, bear a barcode 9, images 11 representing a logo and a flag, alphanumeric characters 12, drawings 13 and a partially demetallized security wire 14.

A method according to a second embodiment of the invention will now be described with reference to FIGS. 7 to 10.

Prior to a step 100 there is a first layer 2, as depicted in FIG. 7, comprising a core sublayer 3 made of a polymer material, similar to that which has just been described. In the example illustrated, this core sublayer is flanked by two adhesive sublayers 5, which may be as described with reference to the first embodiment, being for example hot melt. The first layer 2 is, in the example described, made of Polyart® of type BM.

As depicted in FIG. 7, the first layer 2 comprises a cavity 16. In the example illustrated, this cavity 16 is a through-cavity, which means that it extends through the core sublayer 3 and through each sublayer 4 but, in an alternative, this cavity may be a blind cavity, extending for example only through one of the sublayers 4 and through all or part of the thickness of the sublayer 3.

During step 100, the electronic device 6, which is for example identical to the one described with reference to FIGS. 1 to 6, is introduced into the cavity 16 using a pick and place tool.

During a next step 101, the first layer 2 is assembled with two second layers 10, each second layer being made of a polymer material. FIG. 8 depicts the first layer 2 and the second layers 10 prior to step 101.

The second layers 10 may be made of Polyart® of type BM1C. These second layers 10 each for example comprise a core sublayer 3, a print sublayer 4 and an adhesive sublayer 5.

The polymer material of the second layers 10 may be the same as that of the first layer 2 or may be a different material.

During the assembly step 101, the layer 2 is placed between the second layers 10, and the sublayers that come into contact at the time of assembly may be adhesive sublayers 5.

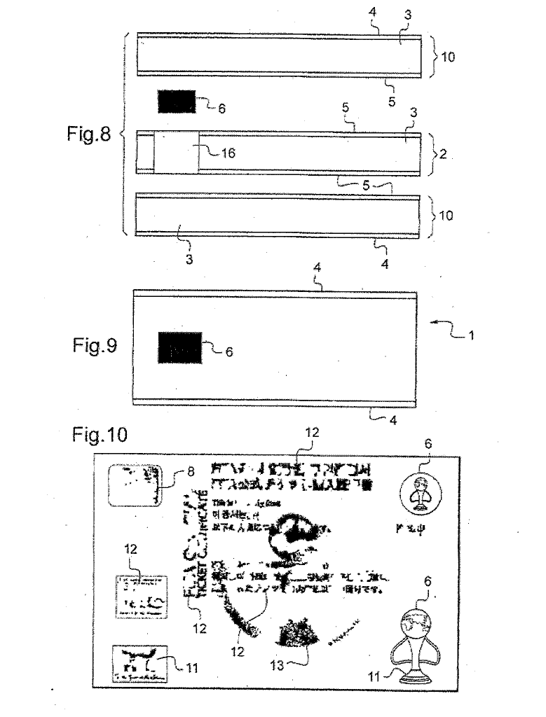

The support 1 as depicted in FIG. 9 may have a recto face and a verso face which are defined by print sublayers 4.

During an optional step 102 similar to the one described earlier, the support 1 may undergo printing treatments and/or have additional security element(s) added.

FIG. 10 depicts an example of an item obtained with the method that has just been described. This item is a document, for example an event ticket, notably a ticket for a sports event, and has a thickness of between 300 and 400 μm, for example of 325 μm.

The item may as depicted comprise two electronic devices 6, images 11 representing for example logos, alphanumeric characters 12, a holographic foil 8 and a drawing 13.

A method of manufacture according to a third embodiment of the invention will now be described with reference to FIGS. 11 to 15.

FIG. 12 depicts an example of a first layer 2′ prior to the step 100′. The first layer 2′ is for example made of Polyart® STES, as described in application WO 2009/083690 and marketed by the company ARJOBEX, or made of Teslin®.

The core sublayer 3′ may be sandwiched between the adhesive sublayer 5′ and the print sublayer 4′. The print sublayer 4′ is for example filled with one or more pigments, for example visible under UV light and/or visible under white light.

During step 100′, at least one electronic device 6′, which is for example as described hereinabove, is inserted into the first layer 2′. The electronic device penetrates both into the adhesive sublayer 5′ and into the thickness of the core sublayer 3′, in a similar way to the previous examples. When the electronic device 6′ comprises an on-chip antenna, this device 6′ may be inserted into the first layer 2′ in such a way that the face of the chip that bears the antenna lies facing the core sublayer 3′. The antenna is thus protected. As depicted in FIG. 13, on completion of this step 100′, the electronic device 6′ may lie in the first layer 2′ without generating additional thickness in comparison with the thickness thereof because the variation in thickness caused by the introduction of the electronic device is compensated for by the core sublayer 3′ and by the adhesive sublayer 5′.

The method may further comprise, as illustrated, a step 104′ in which a heat-sealing lacquer, for example acrylic or polyurethane lacquer, is coated onto at least one layer out of the adhesive sublayer 5′ and the print sublayer 4′. This heat-sealing lacquer may be applied by on-line coating using a method known as the “air knife” or “Champion coating” method. As an alternative, the lacquer is applied by off-line coating, for example using the methods known as the “air knife”, “Champion coating” and “offset” methods.

In the example of FIG. 14a, the support 1′ comprises a first coat of lacquer 17′ coated onto that face of the adhesive sublayer 5′ that defines an exterior face of the first layer depicted in FIGS. 12 and 13 and a second coat of lacquer 18′ coated onto that face of the print sublayer 4′ that defines another exterior face of said first layer 2′. The first and, respectively, second coat of lacquer may then define the recto face 20′ and, respectively, the verso face 21′, of the support 1′. Alternatively, implementations according to the embodiments illustrated in FIGS. 4 and 8 can be provided.

In the example of FIG. 14b, the support 1′ has no second coat of lacquer 18′, only the adhesive sublayer 5′ being coated with the coat of heat-sealing lacquer 17′. When the print sublayer 4′ is not covered with a coat of lacquer, a pattern or solid expanse of ink 25′ can be printed thereon, for example using a security ink. This printing is, for example, performed using ink that is visible or invisible depending on the light and at the location of the electronic device 6′.

A flag for example is printed using colored inks at the location of the electronic device 6′. When viewed from above, the electronic device 6′ may lie inside the external outline of the pattern or of the solid expanse 25′.

During a step 105′, the support 1′ is cut into a plurality of units 30′ of relatively small format such as flakes, each unit 30′ for example having a longest dimension of between 0.5 and 5 mm. Each unit 30′ may comprise at least one electronic device 6′. This cutting is performed for example using a laser or using two successive coaxial cylinders as mentioned above. When a pattern or a solid expanse 25′ has been applied in step 104′, this step 105′ can be done in .register with the applied printing. Thus, the electronic device 6′ and the pattern 25′ are guaranteed to be located on the flake after the cutting step described below. If the support is not cut into flakes, the pattern 25′ may be printed so that it is offset from the electronic device. For example, the pattern 25′ may constitute an additional pattern arranged to indicate the presence of the electronic device and thus make it easier to read. The pattern 25′ may for example take the form of an annulus the center of which marks the location of the electronic device.

As depicted in FIG. 15, when viewed from above, the surface area of a unit 30′ is greater than the surface area of the electronic device 6′ and the entirety of the electronic device 6′ lies within the unit 30′. The cutout may have a decorative shape, for example a geometric pattern such as an ellipse, a circle, a polygon, a rectangle, a square, a star. In this case because the cutting is done in register, the position of the electronic device is marked out in relation to the shape of the support unit, and this constitutes an additional security feature. As an alternative, the cutout may define a written symbol or an image of a recognizable object.

In the example illustrated, a support unit 30′ comprises just one electronic device 6′ but it could comprise more thereof.

In a step 106′, the support units 30′ are introduced into a papermaking machine in a dispersion of fibrous material for the production of all or part of an item, for example security documents. The support units may be introduced continuously into the papermaking machine, i.e. without any intermediate storage of the papermaking fibers. Furthermore, the support units may be sprayed towards the fibrous substance while it is still wet and in progress so as to form a continuous pattern in the form of a strip. As described earlier, the support incorporating several electronic devices can also be cut into a web and introduced in that form into the papermaking machine in the dispersion of fibrous material. The introduction of the support units in the form of a strip or the introduction of a support incorporating several electronic devices in the form of a web means that the layout of the electronic devices is localized in relation to the security document, and this notably makes the electronic devices easier to read.

During a step 107′ a booster antenna may be applied, notably by printing, to the item into which one or more support units are incorporated.

The security document for example comprises several electronic devices 6′. Each chip may have a unique number, for example made up of two letters followed by two numerals, and a corresponding number is inscribed on the document. The reading of the document can be authenticated uniquely by comparing the identification number inscribed on the document with a code resulting for example from the concatenation of the codes from the chips present in said document.

In an alternative, the number inscribed on the document consists of the sum of the codes from the chips.

When the electronic device is a resonant microcircuit, each device 6′ sends back to a detector a unique resonant signal and the final document has an overall resonant circuit resulting from the sum of all the resonant circuits.

The invention is not restricted to the examples that have just been described.

An item thus obtained comprises at least one electronic device and may also comprise at least one security level known as a “level-one” security element and/or at least one security element known as a “level-two” security element as mentioned hereinabove.

The item may in particular comprise, by way of security elements, amongst other things:

luminescent dyes and/or pigments and/or interferential pigments and/or liquid crystal pigments notably in printed form or mixed with at least one layer of which the item is made,
photochromic or thermochromic pigments and/or dyes or components, notably in printed form or mixed with at least one layer of which the item is made,
an ultraviolet (UV) absorber, notably in the form of a coating or mixed with at least one layer of which the item is made,
a specific light-collecting material, for example of the “waveguide” type, for example a luminescent light-collecting material such as the polycarbonate-based polymer films marketed by the BAYER company under the LISA® trade name,
an interferential multilayer film,
a structure with variable optical effects based on interferential pigments or liquid crystals,
a birefrigent or polarizing layer,
a diffraction structure,
an embossed image,
means that produce a “moiré effect”, it being possible for example for such an effect to reveal a pattern produced by the superposition of two security elements on the item, for example by the bringing-together of lines of two security elements,
a partially reflective refractive element,
a transparent lenticular grating,
a lens, for example a magnifying glass,
a color filter,
a security wire for example incorporated within the mass of at least one layer of which the item is made or in a window, possibly bearing printing or reverse-printing, fluorescence, a metallic goniochromatic or holographic effect, with or without one or more demetallized parts,
a metallized, goniochromatic or holographic foil,
a layer with variable optical effect based on interferential pigments or liquid crystals,
a flat security element of relatively small format such as a flake, visible or non-visible, notably luminescent, with or without an electronic device,
particles or agglomerations of particles of pigments or dyes of HI-LITE type, visible or non-visible, notably luminescent,
security fibers, notably metallic, magnetic (mildly and/or highly magnetic) or absorbent security fibers or fibers that can be excited by ultraviolet, visible or infrared light, particularly by near infrared (NIR),
a security feature that can be read automatically and has specific and measurable luminescence (for example fluorescence, phosphorescence), light (for example ultraviolet, visible or infrared) absorption, Raman activity, magnetism, microwave interaction, X-ray interaction or electrical conductivity parameters.

One or more security elements as defined above can be present in the item and/or in one or more layers of which the item is made or in one or more security elements incorporated into the item and/or into one or more layers of which the item is made, such as a wire, a fiber or a flake for example.

At least one of the layers of which the item is made may also contain a level-one security element such as a watermark or a pseudo-watermark that is at least partially superposed on a translucent region of the item.

What is meant according to the invention by a “watermark or pseudo-watermark” is a drawn image that appears within the thickness of the item.

The watermark or pseudo-watermark may be produced in various ways known to those skilled in the art. For that, the item may comprise at least one out of a fibrous or polymer layer, a substructure, an adhesive layer, an external layer or a spacer layer as defined hereafter.

In the claims, the expression “comprising a/an/one” is to be understood as being synonymous with “comprising at least a/an/one” unless specified to the contrary.

1. A method of producing a support comprising at least one electronic device, in which method:
a pick and place tool is used to insert the electronic device into a first layer of the support produced from at least one polymer material.

2. The method as claimed in claim 1, in which the electronic device is chosen from contactless communication integrated microcircuits, chip-based integrated-antenna microcircuits, resonant microcircuits, microcircuits that communicate electromagnetically, microtransponders, microtrans-ponders that react to a beam of diffuse light and microtransponders which are photoactivatable.

3. The method as claimed in claim 1, in which each layer comprises at least one core sublayer that has voids.

4. The method as claimed in claim 1, in which each layer comprises at least one skin sublayer free of voids which is an adhesive sublayer or a print sublayer.

5. The method as claimed in claim 1, in which the pick and place tool is used to insert the electronic device in the first layer by compressing this layer at a location that has no cavity.

6. The method as claimed in claim 5, the electronic device being inserted into the first layer through a void-free skin sublayer of said layer and into the thickness of a core sublayer of said layer that does have voids.

7. The method as claimed in claim 1, in which the first layer is assembled under mechanical stress with at least one second layer of the support in such a way that the electronic device is located between the external faces of the two layers thus assembled.

8. The method as claimed in claim 7, in which, prior to the assembling of the two layers, the face of the first layer via which the electronic device was inserted is positioned facing the other layer.

9. The method as claimed in claim 1, in which each layer comprises a core sublayer, an adhesive skin sublayer and a print skin sublayer, the core sublayer being sandwiched between these two skin sublayers.

10. The method as claimed in claim 1, in which the pick and place tool is used to insert the electronic device in a cavity of the first layer.

11. The method as claimed in claim 10, in which, during assembly, the first layer is positioned between two second layers, said first layer comprising a core sublayer that has voids and two adhesive skin sublayers, the core sublayer being sandwiched between these two adhesive skin sublayers.

12. The method as claimed in claim 11, in which the two second layers assembled with the first layer each comprise an adhesive skin sublayer and a print skin sublayer.

13. The method as claimed in claim 1, comprising printing at least one security pattern at least one print skin sublayer of the support and/or comprising placing at least one security element on an external face of the support.

14. The method as claimed in claim 1, in which the polymer material from which the first layer of the support is made is based on polyolefin or on polyethylene.

15. The method as claimed in claim 1, comprising cutting the support to produce a plurality of support units of relatively small format, notably such as flakes, each support unit comprising at least one electronic device.

16. A method of producing an item, notably a security document, comprising a fibrous substrate, it the method comprises inserting one or more support units, of relatively small format, obtained as claimed in claim 15, into a dispersion of fibrous material intended to form the fibrous substrate of the item in a papermaking machine.

17. A security document such as a passport, an identity card, a driver's license, an interactive collectable trading card or playing card, a payment means, notably a payment card, a coupon or a voucher, a transport card, a loyalty card, a service entitlement card, a subscription card, produced using the method as claimed in claim 16.

18. A method of authenticating and/or identifying a security document comprising a fibrous substrate comprising at least one support unit which is obtained as claimed in claim 16, in which method a code is assigned to each electronic device of each support unit, at least one identifier of the document being inscribed on the security document, and in which:
a code resulting from the combination of the codes of the electronic devices of the security document is determined,
the identifier inscribed on the security document is read, for example visually or automatically, and
the identifier of the security document is compared against the resulting code in order to identify and/or authenticate the item.

19. The method of claim 13, wherein the security pattern is printed using a fluorescent ink.
